(19) United States
(12) Patent Application Publication
(10) Pub. No.: US 2026/0210500 A1
(43) Pub. Date: Jul. 23, 2026

(54) H2 TANK VALVE FOR ARRANGEMENT ON AN H2 TANK OF AN H2-POWERED MOTOR VEHICLE

(71) Applicant: Robert Bosch GmbH, Stuttgart (DE)

(72) Inventors: Dieter Junger, Stuttgart (DE); Andreas Wuetz, Stuttgart (DE); Martin Kessler, Rochlitz (DE)

(21) Appl. No.: 19/138,996

(22) PCT Filed: Nov. 21, 2023
(86) PCT No.: PCT/EP2023/082516

§ 371 Date: Jun. 13, 2025

(30) Foreign Application Priority Data
Dec. 14, 2022 (DE) 10 2022 213 601.2

(51) Int. Cl. F17C 13/04; F17C 13/02; G01K 1/14

(52) U.S. Cl. CPC F17C 13/04; F17C 13/026; G01K 1/14; F17C 2205/0323; F17C 2221/012; F17C 2250/0439; F17C 2270/0168

(57) ABSTRACT

The invention relates to an H₂ tank valve (1) for arrangement on an H₂ tank (40) of an H₂-powered motor vehicle, comprising: at least one flange (42a) for connecting the H₂ tank valve (1) to the interior of the H₂ tank (40), a temperature sensor module (10) arranged at least partially within the at least one flange (42a) for detecting a current temperature within the H₂ tank (40) when the flange (42a) is connected to the H₂ tank (40), a plug connector (30) electrically connectable to the temperature sensor module (10) for current transfer and data transmission, wherein the plug connector (30) is arranged laterally on the outside of the at least one flange (42a).

### BACKGROUND

The present invention is based on a device and a system.

Hydrogen-based fuel cells are considered to be the mobility concept of the future, because they only emit water as exhaust gas and enable fast fueling times. The hydrogen required for the fuel cell reaction is stored in gaseous form under pressure in a tank of a hydrogen-powered vehicle. Hydrogen tank valves are used to safely transfer the hydrogen to a vehicle tank. For safety and calibration reasons in particular, the valves must be equipped with a temperature sensor that is sealed to the outside when a tank is being filled, is located at least partially within the vehicle tank, and measures the temperature there.

For current transfer and data transmission, the temperature sensor must be electrically connected to a power supply and/or control unit or similar via appropriate feedthroughs to the outside. Unfortunately, the cables used for electrically connecting the temperature sensor to the power supply and/or control unit in conventional H₂ tank valves must be routed at a 90° angle within the valves, which makes it considerably more difficult to install an electrical connection cable. Particularly due to assembly deviations that are unavoidable in mass production, manual assembly to establish an electrical connection between the temperature sensor and a plug connector can take up to 5 minutes. An automated process is not even possible due to the assembly deviations.

### SUMMARY

According to a first aspect, the subject of the invention is an H₂ tank valve with the features of the independent device claim and, according to a second aspect, a system with the features of the independent system claim. Further features and details of the invention arise from the respective dependent claims, the description, and the drawings. The features and details described in connection with the device according to the invention naturally also apply in connection with the system according to the invention and vice versa, so that mutual reference can always be made to the disclosure of the individual aspects of the invention.

The advantage of the H₂ tank valve according to the invention for installation on an H₂ tank of an H₂-powered motor vehicle is particularly apparent in that that, due to the arrangement provided by the invention of a temperature sensor module within a flange for connecting the H₂ tank valve to the interior of the H₂ tank and a current transfer and data transmission plug connector arranged laterally on the outside of the flange for electrically connecting the temperature sensor module, an electrical connection between a temperature sensor module and a plug connector can be generated in a structurally simple, fast, and automatable manner, so that manual or fully automatic assembly for establishing an electrical connection is possible within a large-scale production cycle time of approximately 10 seconds. A simpler, faster and, in particular, automatable design not only reduces manufacturing costs, but also generates a more reliable electrical connection between a temperature sensor module and a plug connector as a power supply and/or control unit.

The H₂ tank valve according to the invention for arrangement on an H₂ tank can be used in particular in motor vehicles, such as passenger cars or trucks. It can also be used in other vehicles or means of transportation, such as forklift trucks, cranes, ships or flying objects. Use in stationary systems is also conceivable.

The H₂ tank valve according to the invention for arrangement on an H₂ tank of an H₂-powered motor vehicle comprises at least one flange for connecting the H₂ tank valve to the interior of the H₂ tank, a temperature sensor module arranged at least partially within the at least one flange for detecting a current temperature within the H₂ tank when the flange is connected to the H₂ tank, and a plug connector which can be electrically connected to the temperature sensor module for current transfer and data transmission, wherein the plug connector is arranged laterally on the outside of the at least one flange. Preferably, the H₂ tank valve according to the invention has a valve body with a plurality of flanges for the arrangement of functional components of the H₂ tank valve, wherein the at least one flange for connecting the H₂ tank valve to the interior of the H₂ tank is part of the valve body.

In the context of the invention, a valve body can be understood in particular as the main part of a valve, which is preferably arranged centrally within the H₂ tank valve according to the invention. The flanges arranged on the valve body can preferably be connected to the valve body in one piece. The flanges preferably have a first tubular section and an annular or disk-shaped section at the end, on which, for example, a functional component of the H₂ tank valve, such as a pressure sensor, a pressure relief valve or the like, can be arranged. In the context of the invention, the plug connector in question can be designed in particular in the form of a power supply and/or control unit which can be electrically connected to a sensor module according to the invention via a plug connector.

With regard to a simple and quick establishment of an electrical connection between a temperature sensor module and a plug connector for current transfer and data transmission, the invention advantageously provides that the plug connector is designed as a one-piece plug-in magnet group.

In order to establish a simple electrical connection between a temperature sensor module and a plug connector for current transfer and data transmission, the invention may advantageously provide that that the plug connector has electrical contacting means for establishing an electrical connection with the temperature sensor module, wherein the electrical contacting means are preferably designed in the form of clamping contacts and/or contact pins. Electrical contacting means in the form of contact pins advantageously offer a certain distance and angle tolerance, particularly in the contacting direction, depending on the length and width of the contact surfaces.

With regard to a simple and quick establishment of an electrical connection between a temperature sensor module and a plug connector for current transfer and data transmission, the invention may advantageously provide that that the plug connector is aligned axially with the main alignment axis of the flange and is arranged outside the flange, wherein, in particular, the electrical contacting means of the plug connector protrude from the plug connector at an upper end.

In order to ensure a simple and quick establishment of an electrical connection between a temperature sensor module and a plug connector for current transfer and data transmission, it may also be advantageous, according to the invention, for the temperature sensor module to have a temperature sensor arranged inside a housing and electrical contacting means for establishing an electrical connection with the plug connector, wherein the electrical contacting means are preferably designed in the form of clamping contacts and/or contact pins.

With regard to a simple and quick establishment of an electrical connection between a temperature sensor module and a plug connector for current transfer and data transmission, it is also advantageous for the temperature sensor module to be aligned axially with the main alignment axis (along the main alignment axis) of the flange and arranged within the flange, wherein the temperature sensor module preferably emerges from the flange at an upper end, wherein in particular the electrical contacting means of the temperature sensor module protrude from the flange at the upper end. The upper end in particular forms the end facing away from the tank when connected to an H₂ tank.

In the context of a structurally simple, fast and, in particular, automatable method of manufacturing an electrical connection between a temperature sensor module and a plug connector for current transfer and data transmission, it may also be advantageous to provide a conductor bridge for electrically connecting the temperature sensor module to the plug connector, wherein the conductor bridge is preferably arranged within a conductor channel, wherein the conductor bridge is arranged in particular essentially perpendicular to the flange and/or to the temperature sensor module and/or to the plug connector. The arrangement of such a conductor bridge also allows for greater manufacturing tolerances with regard to distances and angles. A substantially perpendicular arrangement can preferably be understood here as an arrangement that deviates only marginally, e.g., by up to <10°, in particular up to <5°, from an exactly perpendicular arrangement.

With regard to a structurally simple, fast, reliable, and, in particular, automatable production of an electrical connection between a temperature sensor module and a plug connector for current transfer and data transmission, it may also be advantageous to provide that the conductor bridge is designed and arranged between the temperature sensor module and the plug connector in such a way that an electrical connection between the temperature sensor module and the plug connector can be established by means of the conductor bridge via an axial joining process, wherein the axial joining process is preferably designed in the form of a translational movement along the main alignment axis of the flange.

In the context of a particularly reliable and at the same time simple and quick method of producing an electrical connection between a temperature sensor module and a plug connector for current and data transmission, it may also be advantageous to provide that the conductor bridge is designed and arranged between the temperature sensor module and the plug connector such that an electrical connection between the temperature sensor module and the plug connector can be established by means of the conductor bridge via clamping contacts, wherein preferably at least two clamping contacts can be provided, in particular at least two clamping contacts on the side of the temperature sensor module and two clamping contacts on the side of the plug connector. The clamping gaps of the clamping contacts on the side of the temperature sensor module and/or on the side of the plug connector can be designed in particular parallel to the main alignment axis of the flange and/or of the plug connector.

In order to ensure a particularly large manufacturing tolerance with regard to distances and angles in relation to the temperature sensor module and the conductor bridge, it is also conceivable that a radial seal is provided for sealing the conductor bridge relative to the plug connector and/or an axial seal is provided for sealing the conductor bridge relative to the temperature sensor module, wherein the radial seal is preferably arranged between a pin and a ring groove and/or the axial seal is arranged flush in a body recess with radial clearance. A radial seal can be understood here in particular as a seal in which the preload deformation to ensure tightness is achieved by forces acting on the plane of the sealing element (O-ring). An axial seal can be understood as a seal in which the preload deformation to ensure tightness is achieved by forces acting perpendicular to the plane of the sealing element (O-ring).

In order to ensure particularly high sealing and holding forces with regard to sealing the temperature sensor module in question to the H₂ tank, it may be advantageous, according to the invention, to provide screw connections for sealing the temperature sensor module to the H₂ tank, wherein the screw connections are preferably arranged diametrically with respect to the electrical contacting means of the temperature sensor module for establishing an electrical connection with the conductor bridge and/or diametrically with respect to connection regions of the conductor bridge for electrically connecting to the temperature sensor module.

The invention also relates to a system comprising an H₂ tank of an H₂-powered motor vehicle and an H₂ tank valve according to the invention.

The system according to the invention thus has the same advantages as those already described in detail in relation to the H₂ tank valve according to the invention.

In addition, a motor vehicle, in particular a fuel cell-powered vehicle, comprising a system described above is also the subject of the invention. Thus, the motor vehicle according to the invention also has the same advantages as those already described in detail in relation to the H₂ tank valve according to the invention and the system according to the invention.

### BRIEF DESCRIPTION OF THE DRAWINGS

Further advantages, features, and details of the invention arise from the following description, in which exemplary embodiments of the invention are described in detail with reference to the drawings. The features mentioned in the claims and in the description can each be essential to the invention individually or in any combination.

Shown are:

FIG. 1 a schematic illustration of a part of an H₂ tank valve according to the invention according to a first exemplary embodiment in a sectional view,

FIG. 2 a schematic illustration of a part of an H₂ tank valve according to the invention according to the first exemplary embodiment in a further sectional view,

FIG. 3 a schematic illustration of a part of a plug connector according to the invention according to a first exemplary embodiment in a sectional view,

FIG. 4 a further schematic illustration of a part of a plug connector according to the invention according to a first exemplary embodiment in a sectional view,

### DETAILED DESCRIPTION

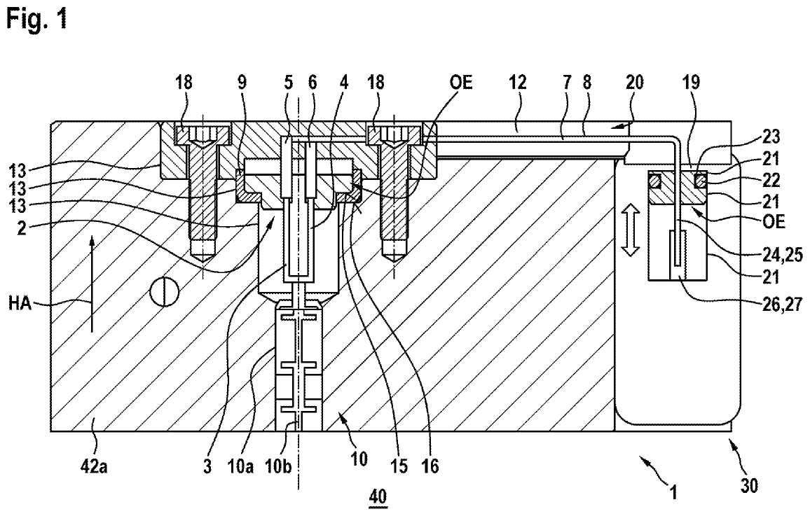

FIG. 1 shows a schematic illustration of a part of an H₂ tank valve 1 according to the invention for arrangement on an H₂ tank 40 of an H₂-powered motor vehicle according to a first exemplary embodiment in a sectional view.

The H₂ tank valve 1 in question comprises at least one flange 42a for connecting the H₂ tank valve 1 to the interior of the H₂ tank 40, a temperature sensor module 10 arranged at least partially within the at least one flange 42a for detecting a current temperature within the H₂ tank 40 when the flange 42a is connected to the H₂ tank 40, and a plug connector 30 electrically connected to the temperature sensor module 10 for current transfer and data transmission, which is arranged laterally on the outside of the at least one flange 42a.

As can be seen in FIG. 1, the plug connector 30 has electrical contacting means for establishing an electrical connection with the temperature sensor module 10, which are designed in this case in the form of clamping contacts 24, 25 and contact pins 26, 27.

The plug connector 30 is aligned axially with the main alignment axis HA of the flange 42a (along the flange) and arranged outside the flange 42a, wherein the electrical contacting means of the plug connector 30 protrude from the plug connector 30 at an upper end OE.

The temperature sensor module 10 further comprises a temperature sensor 10b arranged inside a housing 10a and electrical contacting means for establishing an electrical connection with the plug connector 30, which are designed in the form of clamping contacts 3, 4 and contact pins 5, 6.

The temperature sensor module 10 is aligned axially with the main alignment axis HA of the flange 42a and arranged within the flange 42a, wherein the temperature sensor module 10, in particular the electrical contacting means of the temperature sensor module 10, protrude from the flange 42a at the upper end OE.

In addition, FIG. 1 shows that a conductor bridge 20 is provided for electrically connecting the temperature sensor module 10 to the plug connector 30, which is arranged within a conductor channel 12 to the flange 42a and to the temperature sensor module 10 and to the plug connector 30.

The conductor bridge 20 can be connected to the temperature sensor module 10 and the plug connector 30 by means of an axial joining process in the form of a translational movement along the main alignment axis HA of the flange 42a.

Furthermore, FIG. 1 shows that a radial seal 22 is provided for sealing the conductor bridge 20 and the plug connector 30, and an axial seal 9 is provided for sealing the conductor bridge 20 and the temperature sensor module 10 to the outside, wherein the radial seal 22 is arranged between a pin 19 and a ring groove 23 and the axial seal 9 is arranged flush in a body recess with radial clearance 17.

The temperature sensor module 10 shown here can be electrically connected by a straight movement along the main alignment axis HA via a connection of the clamping contacts 3, 4 with the contact pins 5, 6, by the conductor bridge 20 extending on the outside of the housing undergoing a shift axially along the main axis HA in the direction of the temperature sensor 10a, thereby simultaneously contacting the plug connector 30 via a further plug connector the clamping contacts 24, 25 with the contact pins 26, 27.

The round mounting geometry on plug connector 30 and the contact housing with radial clearance 17 relative to the stepped bore 13, in combination with the axial seal 9 and the plug contact 2 oriented in the longitudinal direction of the conductor bridge 20, make it particularly easy to compensate for distance and angle tolerances in this case.

The temperature sensor module 10 is designed such that the temperature sensor housing 10a with the temperature sensor element 10b contained therein extends axially parallel from the tank 40 to the side facing away from the tank and is electrically connected to a conductor bridge 20 via a plug connector 2. The plug connector 2 is preferably designed as a clamping contact, wherein two fork-shaped clamping contacts 3, 4 protrude so far that the ends of the conductor tracks 7, 8, which are designed as contact pins 5, 6, partially protrude into the fork-shaped openings of the clamping contacts 3, 4 when the conductor bridge 20 is mounted. The opening width of the fork-shaped clamping contacts 3, 4 is smaller than the thickness of the contact pins 5, 6, so that a contact force is formed after joining which is greater than the release forces from operation (acceleration, temperature expansion, etc.). Starting from the contact pins 5, 6, the conductor tracks 7, 8 of the conductor bridge 20 run, protected from impact, in a conductor channel 12 to the plug connector 30, which is preferably firmly connected to a magnet group. The fork-shaped clamping contacts 3, 4, 24, 25 can be formed either on the conductor bridge 20 or on the T-sensor 10 or plug connector 30.

The side of the temperature sensor module facing the conductor bridge 20 has an axially oriented stepped pin 14 with a circular cross-section, which receives the axial seal 9, which is designed here as a lip seal. The axial seal 9 allows axial preload to be exerted between a flat surface 15 formed on the pin 14 and a stepped bore 13 at the end of a flat surface 16, which receives the plug connector 2 and the pin 14.

The pin 14 and the axial seal 9 also have greater clearance in the stepped bore 13 in the transverse direction relative to the bore axis, which allows positional errors, in particular those caused by increased manufacturing tolerances, to be compensated for by means of an offset. Starting from pin 14, diametrically opposed hold-down elements in the form of screw connections 18 are also arranged outside the seal 9. These are aligned in the axial direction and exert a high sealing and holding force.

The axially oriented circular cylindrical pin 19 is arranged at the side of the plug connector of the conductor bridge 20 and is received with a small amount of clearance in a cylindrical bore 21. The cylindrical bore 21 also serves as a sealing surface for the radial seal 22, which is formed in this case in the form of an O-ring. The radial seal 22 is arranged in the ring groove 23 of the pin 19 and seals the conductor bridge 20 and the plug connector 30 from the environment.

At the front side of the pin 21, the electrical contacting means in the form of clamping contacts 24, 25 also protrude, which establish electrical contact with the contact tabs 26, 27 protruding from the receiving bore 21.

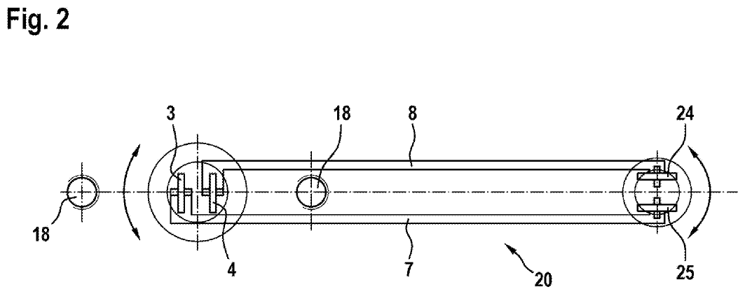

FIG. 2 shows a schematic illustration of a sectional view through the electrical connection between the temperature sensor module 10 and the plug connector 30 of the H₂ tank valve 1 according to the invention in the form of a conductor bridge 20 with conductor tracks 7, 8, which are connected at their ends via electrical contacting means in the form of clamping contacts 3, 4 or 24, 25. It is understood that the conductor tracks 7, 8, which are straight and parallel to each other in the present embodiment, may also be designed differently, for example, at an angle to each other.

FIG. 2 shows in particular that the combination of a round receiving geometry on the plug connector 30, the clamping contacts 3, 4 provided with radial clearance 17, and the conductor bridge 20 according to the invention allows large distance and angle tolerances to be accommodated.

In addition, FIG. 2 shows the diametrically arranged hold-down devices in the form of screw connections 18, which are aligned in the axial direction of the flange 42a or the temperature sensor module 10 and enable a high sealing and holding force.

The preceding description of the embodiments describes the present invention exclusively in the context of examples. Of course, individual features of the embodiments can be freely combined with one another, provided that this is technically meaningful, without departing from the scope of the present invention.

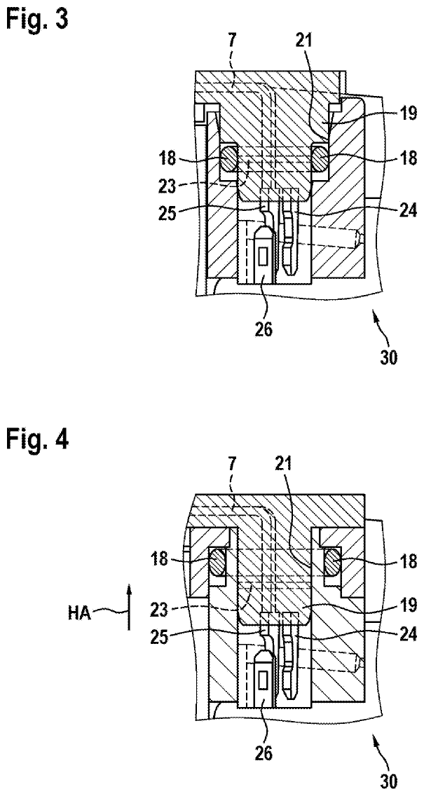

FIG. 3 shows a schematic illustration of part of a plug connector 30 according to the first exemplary embodiment in an enlarged sectional view. As can be seen from this view, an O-ring groove can be formed by a stepped pin 19 and a stepped bore 21.

FIG. 4 shows a further enlarged schematic illustration of a part of a plug connector 30 according to the first exemplary embodiment in a sectional view.

As can be seen from this view, if the main alignment axis HA is installed in a position opposite to the direction of gravity, water accumulation in front of the radial seal 22 can be prevented in an advantageous subvariant, thereby preventing the force exerted by freezing water. This creates an (environmental) opening in the direction of gravity toward the sealing area, so that no water can accumulate in front of the seal 22.

1. An H₂ tank valve (1) for arrangement on an H₂ tank (40) of an H₂-powered motor vehicle, the H₂ tank valve (1) comprising:
at least one flange (42a) for connecting the H₂ tank valve (1) to an interior of the H₂ tank (40),
a temperature sensor module (10) arranged at least partially within the at least one flange (42a) for detecting a current temperature within the H₂ tank (40) when the at least one flange (42a) is connected to the H₂ tank (40),
a plug connector (30) electrically connectable to the temperature sensor module (10) for current transfer and data transmission,
wherein
the plug connector (30) is arranged laterally on an outside of the at least one flange (42a).

2. The H₂ tank valve (1) according to claim 1,
wherein
the plug connector (30) is a one-piece plug-in magnet group.

3. The H₂ tank valve (1) according to claim 1,
wherein
the plug connector (30) has electrical contacting means for establishing an electrical connection with the temperature sensor module (10).

4. The H₂-tank valve (1) according to claim 1,
wherein
the plug connector (30) is aligned axially with a main alignment axis (HA) of the at least one flange (42a) and is arranged outside the at least one flange (42a).

5. The H₂-tank valve (1) according to claim 1,
wherein
the temperature sensor module (10) has a temperature sensor (10b) arranged inside a housing (10a) and electrical contacting means for establishing an electrical connection with the plug connector (30).

6. The H₂-tank valve (1) according to claim 1,
wherein
the temperature sensor module (10) is aligned axially with a main alignment axis (HA) of the at least one flange (42a) and is arranged within the at least one flange (42a).

7. The H₂-tank valve (1) according to claim 1,
wherein
a conductor bridge (20) is provided for electrically connecting the temperature sensor module (10) to the plug connector (30).

8. The H₂-tank valve (1) according to claim 7,
wherein
the conductor bridge (20) is configured and arranged between the temperature sensor module (10) and the plug connector (30) such that an electrical connection between the temperature sensor module (10) and the plug connector (30) can be established by the conductor bridge (20) via an axial joining process.

9. The H₂ tank valve (1) according to claim 7,
wherein
the conductor bridge (20) is configured and arranged between the temperature sensor module (10) and the plug connector (30) such that an electrical connection between the temperature sensor module (10) and the plug connector (30) can be established by the conductor bridge (20) via clamping contacts.

10. The H₂-tank valve (1) according to claim 7,
wherein
a radial seal (22) is provided for sealing the conductor bridge (20) relative to the plug connector (30) and/or an axial seal (9) is provided for sealing the conductor bridge (20) relative to the temperature sensor module (10).

11. The H₂-tank valve (1) according to claim 1,
wherein
screw connections (18) are provided for sealing the temperature sensor module (10) to the H₂ tank (40).

12. A system comprising an H₂ tank (40) of an H₂-powered motor vehicle as well as an H₂ tank valve (1) according to claim 1.

13. The H₂-tank valve (1) according to claim 3, wherein the electrical contacting means are clamping contacts (24, 25) and/or contact tabs (26, 27).

14. The H₂-tank valve (1) according to claim 3, wherein the plug connector (30) is aligned axially with a main alignment axis (HA) of the at least one flange (42a) and is arranged outside the at least one flange (42a), and wherein the electrical contacting means of the plug connector (30) protrude out of the plug connector (30) at an upper end (OE).

15. The H₂-tank valve (1) according to claim 5, wherein the electrical contacting means are clamping contacts (3, 4) and/or contact tabs (5, 6).

16. The H₂-tank valve (1) according to claim 6, wherein the temperature sensor module (10) emerges from the at least one flange (42a) at an upper end (OE), and wherein an electrical contacting means of the temperature sensor module (10) protrude from the at least one flange (42a) at the upper end (OE).

17. The H₂-tank valve (1) according to claim 8, wherein the axial joining process is a translational movement along a main alignment axis (HA) of the at least one flange (42a).

18. The H₂ tank valve (1) according to claim 9, wherein at least two clamping contacts are provided on a side of the temperature sensor module and two clamping contacts are provided on a side of the plug connector.

19. The H₂-tank valve (1) according to claim 10, wherein the radial seal (22) is arranged between a pin (19) and a ring groove (23) and/or the axial seal (9) is arranged flush in a body recess with radial clearance (17).

20. The H₂-tank valve (1) according to claim 11, wherein the screw connections (18) are arranged diametrically with respect to electrical contacting means of the temperature sensor module (10) for establishing an electrical connection with a conductor bridge (20) and/or diametrically with respect to connection regions of the conductor bridge (20) for electrical connection with the temperature sensor module (10)
